(19) United States
(12) Patent Application Publication
(10) Pub. No.: US 2011/0117526 A1
(43) Pub. Date: May 19, 2011

(54) TEACHING GESTURE INITIATION WITH REGISTRATION POSTURE GUIDES

(75) Inventors: Daniel J. Wigdor, Seattle, WA (US); Hrvoje Benko, Seattle, WA (US)

(73) Assignee: MICROSOFT CORPORATION, Redmond, WA (US)

(21) Appl. No.: 12/619,585

(22) Filed: Nov. 16, 2009

(51) Int. Cl. G09B 19/00

(52) U.S. Cl. 434/118; 345/173

(57) ABSTRACT

A method for providing multi-touch input initiation training on a display surface is disclosed. A set of one or more registration hand postures is determined, where each registration hand posture corresponds to one or more gestures executable from that registration hand posture. A registration posture guide is displayed on the display surface. The registration posture guide includes a catalogue for each registration hand posture, where the catalogue includes a contact silhouette showing a model touch-contact interface between the display surface and that registration hand posture.

### BACKGROUND

Multi-touch gesture input on display surfaces can be used in a variety of different applications. For example, computing systems with interactive display surfaces can be configured to utilize multiple finger and whole hand touch inputs as forms of user input to control system operation.

### SUMMARY

The present disclosure describes multi-touch input initiation training on a display surface configured to detect multi-touch input. A set of one or more registration hand postures is determined, where each registration hand posture corresponds to one or more gestures executable from that registration hand posture. A registration posture guide is displayed on the display surface. The registration posture guide includes a catalogue for each registration hand posture, where the catalogue includes a contact silhouette showing a model touch-contact interface between the display surface and that registration hand posture.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 shows an example of multi-touch user input on a display surface.

FIG. 2 shows another example of multi-touch user input on a display surface.

FIG. 3 shows an example of a registration posture guide displayed on a display surface.

FIGS. 4, 5, and 6 show examples of catalogues which may be included in a registration posture guide.

FIG. 7 shows an example method for providing multi-touch input initiation training on a display surface.

FIG. 8 schematically shows an example embodiment of a computing device including a display surface configured to detect multi-touch user input.

### DETAILED DESCRIPTION

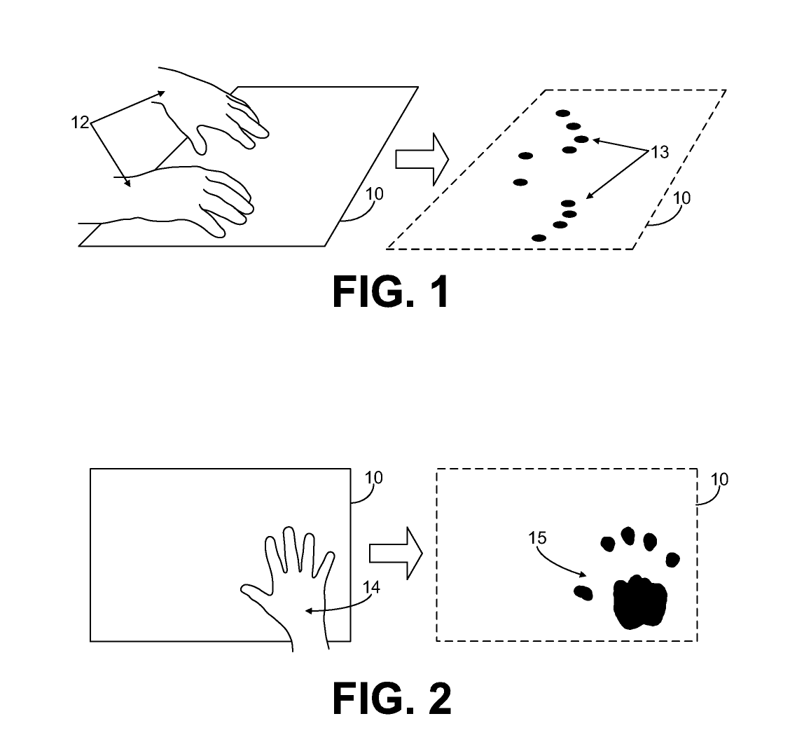

Computing systems may include interactive display surfaces configured to detect multi-touch user input. For example, FIG. 1 and FIG. 2 show a display surface 10 configured to detect finger and whole hand multi-touch input. Examples of multi-touch input on a display surface may include single finger touch input, multi-finger touch input, single shape touch input (e.g., a region of a hand in contact with the display surface), multi-shape touch input (e.g., one or more regions of one or more hands in contact with the display surface), and/or combinations thereof.

FIG. 1 shows an example of hands 12 performing multi-finger touch input on display surface 10. In FIG. 1, tips of the fingers and thumbs of the hands 12 are in contact with the display surface 10. At 13, FIG. 1 also schematically shows how display surface 10 perceives touch input from hands 12. As shown, display surface 10 is capable of perceiving each finger and thumb individually.

FIG. 2 shows an example of a hand 14 performing multi-shape touch input on display surface 10. In FIG. 2, finger portions, thumb portions, and palm portions of hand 14 are in contact with the display surface 10. At 15, FIG. 2 also schematically shows how display surface 10 perceives touch input from hand 14. As shown, display surface 10 is capable of perceiving the touch contact interface or the general shape of those portions of the hand that are in contact with the display surface.

A computing system with an interactive display surface can be controlled by one or more users at least in part by multi-touch input on the display surface. For example, a user may touch the display surface with one or both hands and complete a hand gesture while maintaining contact with the surface to move or resize an object displayed on the surface. As another example, a user may tap one or more fingers on the display surface while performing a hand gesture in contact with the surface to carry out various computing system actions associated with the hand gesture. For example, a user may resize an object by sliding two fingers in contact with the surface together.

Given all the finger and hand pose touch input variations possible on an interactive display surface, the space of possible gestures is very large. Further, in such computing systems, the mapping of multi-touch gesture input to system actions may be complex or unfamiliar to inexperienced or infrequent users. For example, there may be many different multi-touch hand gestures for a user to learn in order to effectively interact with such a system. Thus, multi-touch computing system input may be difficult for a user to learn, and this difficulty may prevent the user from effectively using such a system.

The initial multi-touch input on the display surface for a given multi-touch gesture is referred to as the registration hand posture of that multi-touch gesture. A user performs a registration hand posture on the display surface to begin the multi-touch gesture, and then completes the multi-touch gesture with a continuation posture and/or movement. As used herein, movement refers to touch input that follows a path along the surface; and a continuation posture refers to the fingers moving relative to one another while the overall position of the hand remains substantially stationary relative to the display surface.

A registration hand posture for a single finger gesture includes the initial touch of that finger against the display surface; the registration hand posture for a multi-finger gesture includes the initial touch of the multiple fingers against the display surface; the registration hand posture for a single shape gesture includes the initial touch of a single portion of a hand against the display surface (e.g., palm shape); and the registration hand posture for a multi-shape gesture includes the initial touch of multiple portions of one or more hands against the display surface (e.g., palm shape and finger shape).

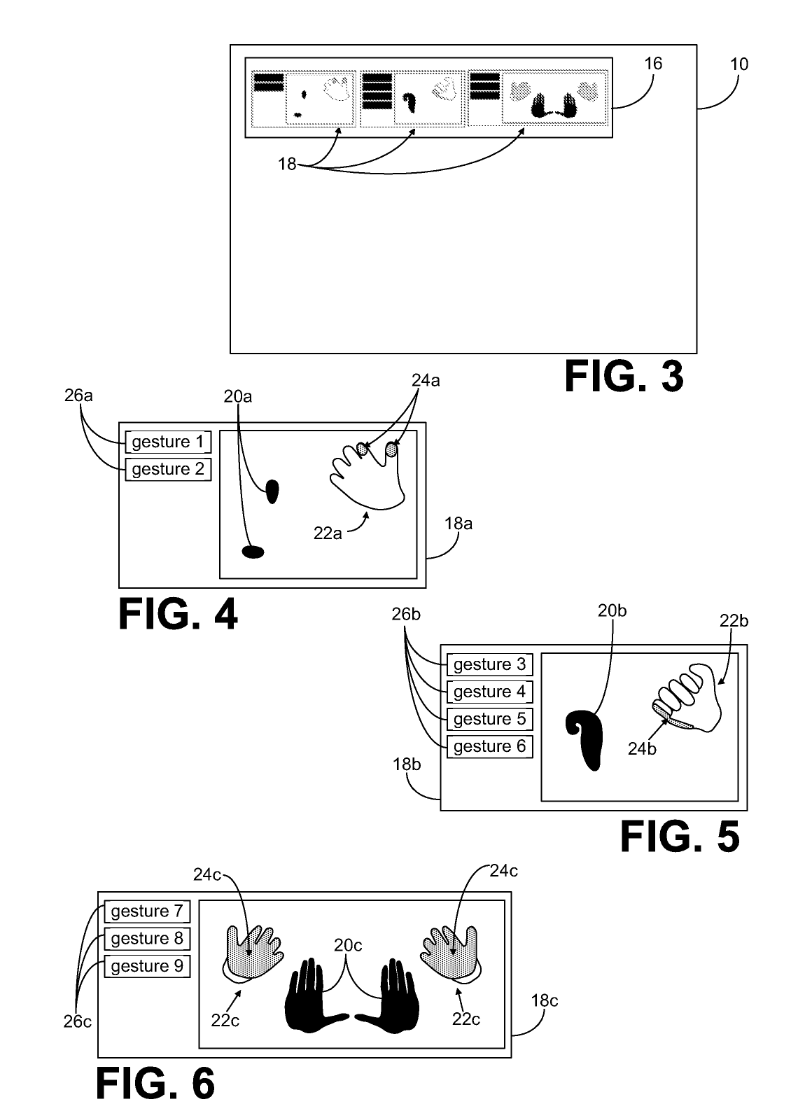

FIG. 3 schematically shows a nonlimiting example of a registration posture guide 16 displayed on display surface 10. A registration posture guide displayed on the display surface may teach a user how to put their hands in contact with the display surface in order to start a desired gesture. By displaying a registration posture guide on the display surface, users may be informed of available gestures and corresponding registration hand postures that may be performed. In this way, the transition in user skill level from novice to expert use may be eased while providing system usability to users at all skill levels.

A registration posture guide may be displayed on the display surface under a variety of different conditions without departing from the scope of this disclosure.

As a nonlimiting example, a registration posture guide may be displayed following a user request. In some scenarios, a user may be uncertain about what gestures are available in a given computing system context. Available gestures may change depending on what applications are running on the system. In some scenarios, the user may be uncertain how to begin a gesture in order to carry out a particular system action. For example, a user may be uncertain about whether to use one or both hands to perform a gesture. In such scenarios, the user may request that a registration posture guide be displayed on the display surface. For example, the user may press a virtual menu call-up button to request that a registration posture guide be displayed.

As another nonlimiting example, the registration posture guide may be displayed following a hesitation or pause in movement of a touch input. In some scenarios, the display surface may automatically display a registration posture guide after a threshold period of inactivity. In some scenarios, a user may incorrectly begin a gesture and then pause to allow the registration posture guide to be displayed.

A registration posture guide may be displayed on the display surface in a variety of ways. For example, the registration posture guide may be a pop-up panel displayed on the display surface. In some examples, the registration posture guide may be displayed toward an edge of the display surface or the registration posture guide may be partially translucent, so as not to occlude other objects displayed on the display surface.

In FIG. 3, registration posture guide 16 is shown positioned adjacent to two edges of display surface 10. The registration posture guide 16 includes a plurality of catalogues 18. As used herein, a catalogue refers to one or more constituent elements that alone, or in combination, can be used to teach a user how to perform a particular registration hand posture, and/or teach a user which gestures may be performed from that particular registration hand posture. FIGS. 4, 5, and 6 show nonlimiting examples of catalogues which may be included in a registration posture guide.

A registration posture guide may include a catalogue for each available registration hand posture. For example, depending on a computing system context (e.g., what applications are running or what tasks are to be performed in the computing system), a set of one or more registration hand postures that correspond to currently available gestures may be determined. Each catalogue included in the registration posture guide may guide a user to perform the registration hand posture corresponding to that catalogue.

Each catalogue in a registration posture guide includes information instructing a user how to perform the registration hand posture associated with that catalogue. For example, if a set of one or more registration hand postures includes a first registration hand posture and a second registration hand posture, then the registration posture guide may include a first catalogue and a second catalogue associated with the first and second registration hand postures, respectively, where the first catalogue is different from the second catalogue. In this example, the first catalogue guides a user to perform the first registration hand posture and the second catalogue guides the user to perform the second registration hand posture. For example, each catalogue may include diagrams of the associated registration hand posture in order to guide a user to perform that registration hand posture.

Catalogues included in a registration posture guide may include a variety of information guiding a user to perform the registration hand posture associated with each catalogue. For example, a catalogue may include one or more images depicting the associated registration hand posture and textual descriptions of the associated registration hand posture.

In some examples, catalogues may include a contact silhouette showing a model touch-contact interface between the display surface and that registration hand posture. For example, FIG. 4 shows a catalogue 18a that includes a contact silhouette 20a. Contact silhouette 20a shows a model touch-contact interface of a finger and thumb of a hand touching the display surface. FIG. 5 shows a catalogue 18b that includes a contact silhouette 20b. Contact silhouette 20b shows a model touch-contact interface of a region of a fist touching the display surface. FIG. 6 shows a catalogue 18c that includes a contact silhouette 20c. Contact silhouette 20c shows a model touch-contact interface of two side-by-side open hands touching the display surface. The catalogues provide information to the user as to what regions of the hands are expected to contact the display surface in order to perform a specific registration hand posture.

A catalogue included in the registration posture guide may also include a representation of one or more hands indicating parts of the one or more hands that are usable to establish the model touch-contact interface between the display surface and the registration hand posture associated with that catalogue. For example, in FIG. 4, catalogue 18a includes a hand representation 22a. Hand representation 22a includes indications 24a that highlight a finger and thumb useable to establish the registration hand posture of catalogue 18a. FIG. 5 shows a hand representation 22b. Hand representation 22b includes an indication 24b that highlights a shaped fist useable to establish the registration hand posture of catalogue 18b. FIG. 6 shows hand representations 22c. Hand representation 22c includes indications 24c that highlight the palm sides of two open hands useable to establish the registration hand posture of catalogue 18c.

The parts of the representation of one or more hands that are usable to perform the registration hand posture may be indicated in a variety of different ways. In some examples, the indications may include highlighted regions and/or color-coded regions of the representation of one or more hands.

A catalogue may be used to show which portions of the hand can be used to perform a registration posture and how the contact interface between the hand and the display surface should look if those portions of the hand are used. Together, the contact silhouette and the representation of the hand may teach an expert style for starting each gesture. For example, if a two finger gesture requires a large separating movement, it may be difficult to perform it with a single hand, thus the registration posture guide may guide the user to perform the registration posture with contacts from two different hands.

Each catalogue may further include one or more gestures available from the registration hand posture associated with that catalogue. For example, FIG. 4 shows a plurality of generically labeled gestures 26a that may be performed from the registration hand posture of catalogue 18a. FIG. 5 shows a plurality of generically labeled gestures 26b that may be performed from the registration hand posture of catalogue 18b. FIG. 6 shows a plurality of generically labeled gestures 26c that may be performed from the registration hand posture of catalogue 18c.

The gestures available from a given registration hand posture may be displayed in a catalogue in a variety of ways. For example, the gestures may be displayed in the catalogue as a list, images, icons, etc. The gestures may further be color-coded. For example, the gestures available from a given registration hand posture may include a first gesture displayed with a first color and a second gesture displayed with a second color different from the first color. Further, in some examples, the catalogues may include descriptions of computing system actions associated with the gestures available from a given registration hand posture.

It is to be understood that the examples provided above are not limiting. Furthermore, the individual aspects described in each example may be combined. For example, a registration posture guide may include catalogues with one or a combination of contact silhouettes, hand representations, textual descriptions, gestures, and/or other information providing a user with instructions on how to perform a registration hand posture.

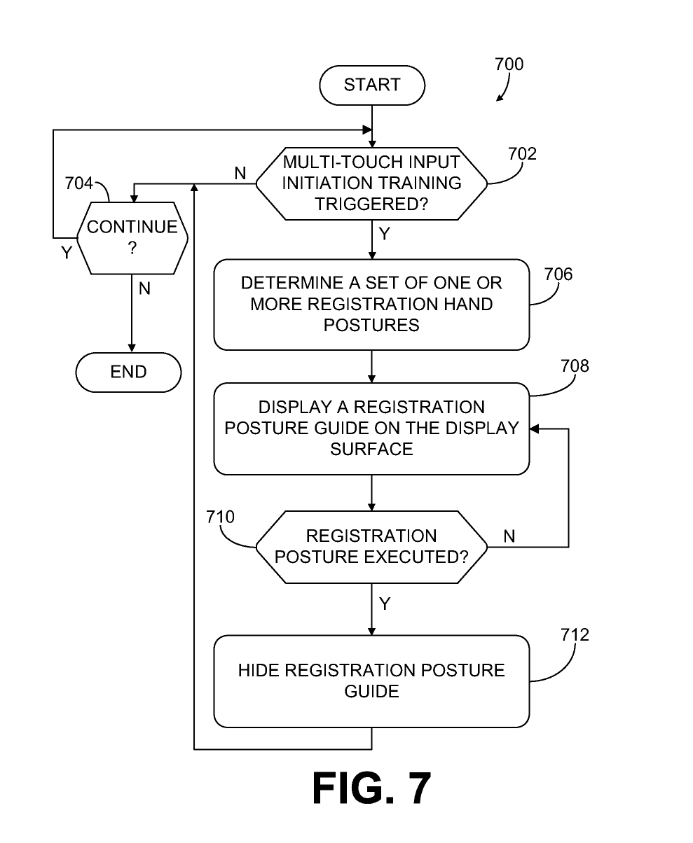

FIG. 7 shows an example method 700 for providing multi-touch input initiation training on a display surface by displaying a registration posture guide on the display surface to guide a user to initiate a gesture.

At 702, method 700 includes determining if multi-touch input training is triggered. For example, multi-touch input training may be triggered by a user request. For example, a user may initiate a contact with the display surface in order to request a triggering of the multi-touch input training. In other examples, the multi-touch input training may be triggered responsive to a hesitation or pause in movement of a touch input. For example, multi-touch input training may be triggered when a touch input on the display surface fails to change at a predetermined rate.

If the answer at 702 is no, flow moves to 704, where it is determined if the method should continue. If the answer at 704 is yes (e.g., an application and/or operating system remains in a state to receive user input), flow moves back to 702. If the answer at 704 is no (e.g., an application and/or operating system blocks user input), the method ends.

If the answer at 702 is yes, flow moves to 706. At 706, method 700 includes determining a set of one or more registration hand postures, where each registration hand posture corresponds to one or more gestures executable from that registration hand posture. The set of one or more registration hand postures may depend on various operating conditions of the computing system. For example, the set of one or more registration hand postures may depend on a mapping of gestures to system actions as stored in a memory storage component of the computing system.

At 708, method 700 displays a registration posture guide on the display surface. As described above, the registration posture guide may include a catalogue for each registration hand posture. The catalogue for each registration hand posture may include a contact silhouette showing a model touch-contact interface between the display surface and that registration hand posture, a representation of one or more hands indicating parts of the one or more hands that are usable to establish the model touch-contact interface between the display surface and that registration hand posture, and gestures available from that registration hand posture.

At 710, method 700 determines if a registration posture is executed. If the answer at 710 is no, flow may move back to 708, where a registration posture guide to guide the user to initiate a gesture may continue to be displayed on the display surface.

If the answer at 710 is yes, flow moves to 712. For example, if a computing system detects a user input and associates the user input with a particular registration posture, flow moves to 712. At 712, upon execution of a gesture, method 700 optionally includes hiding the registration posture guide. For example, the registration posture guide may be hidden when a touch input on the display surface changes at a predetermined rate. In some embodiments, the registration posture guide may continue to be displayed on the display surface to guide a user even when touch input gestures are being performed on the display surface. Flow then moves to 704 where it is determined if the method is to be continued.

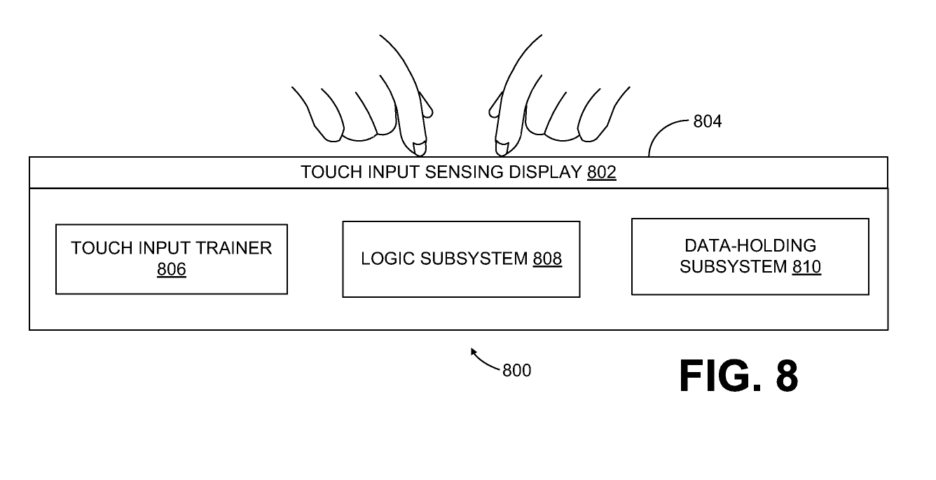

The above described methods and processes may be tied to a computing device. FIG. 8 shows a schematic depiction of an example computing device 800 including a touch input sensing display 802 configured to visually present images to a user and detect multi-touch input on the display surface 804. The touch input sensing display 802 may be any suitable touch display, nonlimiting examples of which include touch-sensitive liquid crystal displays, touch-sensitive organic light emitting diode (OLED) displays, and rear projection displays with infrared, vision-based, touch detection cameras. The touch input sensing display 802 may be configured to detect user-input of various types. For example, multi-touch input by one or more users via one or more objects contacting display surface 804. Examples include, hand contact input, stylus contact input, etc.

The computing device 800 may further include a touch input trainer 806 operatively connected to touch input sensing display 802. The touch input trainer may be configured to determine a set of one or more registration hand postures, where each registration hand posture corresponds to one or more gestures executable from that registration hand posture. The touch input trainer may also be configured to display a registration posture guide on the display surface, where the registration posture guide includes a catalogue for each registration hand posture. As described above, a catalogue may include a contact silhouette showing a model touch-contact interface between the display surface and that registration hand posture. In this way, the touch input trainer 806 may guide a user of computing device 800 to perform a registration hand posture to execute a gesture.

Computing device 800 includes a logic subsystem 808 and a data-holding subsystem 810. Logic subsystem 808 may include one or more physical devices configured to execute one or more instructions. For example, the logic subsystem may be configured to execute one or more instructions that are part of one or more programs, routines, objects, components, data structures, or other logical constructs. Such instructions may be implemented to perform a task, implement a data type, transform the state of one or more devices, or otherwise arrive at a desired result. The logic subsystem may include one or more processors that are configured to execute software instructions. Additionally or alternatively, the logic subsystem may include one or more hardware or firmware logic machines configured to execute hardware or firmware instructions. The logic subsystem 808 may optionally include individual components that are distributed throughout two or more devices, which may be remotely located in some embodiments. Furthermore the logic subsystem 808 may be in operative communication with the touch input sensing display 802 and the touch input trainer 806.

Data-holding subsystem 810 may include one or more physical devices configured to hold data and/or instructions executable by the logic subsystem to implement the herein described methods and processes. When such methods and processes are implemented, the state of data-holding subsystem 810 may be transformed (e.g., to hold different data). Data-holding subsystem 810 may include removable media and/or built-in devices. Data-holding subsystem 810 may include optical memory devices, semiconductor memory devices, and/or magnetic memory devices, among others. Data-holding subsystem 810 may include devices with one or more of the following characteristics: volatile, nonvolatile, dynamic, static, read/write, read-only, random access, sequential access, location addressable, file addressable, and content addressable. In some embodiments, logic subsystem 808 and data-holding subsystem 810 may be integrated into one or more common devices, such as an application specific integrated circuit or a system on a chip.

While described above with reference to a multi-touch display surface in which touch input is executed directly on the user interface, the concepts described herein may be applied to virtually any multi-touch input device. In some embodiments, a registration posture guide may be implemented by devices in which the touch functionality is separated from the display functionality. As an example, a multi-touch track pad may be used to receive the multi-touch input, while a separate display is used to present the registration posture guide.

It is to be understood that the configurations and/or approaches described herein are exemplary in nature, and that these specific embodiments or examples are not to be considered in a limiting sense, because numerous variations are possible. The specific routines or methods described herein may represent one or more of any number of processing strategies. As such, various acts illustrated may be performed in the sequence illustrated, in other sequences, in parallel, or in some cases omitted. Likewise, the order of the above-described processes may be changed.

The subject matter of the present disclosure includes all novel and nonobvious combinations and subcombinations of the various processes, systems and configurations, and other features, functions, acts, and/or properties disclosed herein, as well as any and all equivalents thereof.

1. A method for providing multi-touch input initiation training on a display surface configured to detect multi-touch input, comprising:
determining a set of one or more registration hand postures, each registration hand posture corresponding to one or more gestures executable from that registration hand posture; and
displaying a registration posture guide on the display surface, the registration posture guide including a catalogue for each registration hand posture, the catalogue including a contact silhouette showing a model touch-contact interface between the display surface and that registration hand posture.

2. The method of claim 1, wherein the catalogue further includes a representation of one or more hands indicating parts of the one or more hands that are usable to establish the model touch-contact interface between the display surface and that registration hand posture.

3. The method of claim 2, wherein the indication of parts of the one or more hands that are usable to establish the model touch-contact interface between the display surface and that registration hand posture includes highlighted regions of the representation of one or more hands.

4. The method of claim 1, wherein the catalogue further includes gestures available from that registration hand posture.

5. The method of claim 4, wherein the gestures available from that registration hand posture includes a first gesture displayed with a first color and a second gesture displayed with a second color different from the first color.

6. The method of claim 1, wherein determining a set of one or more registration hand postures and displaying a registration posture guide on the display surface is triggered by a user request.

7. The method of claim 6, wherein the user request includes a touch input on the display surface.

8. The method of claim 1, wherein determining a set of one or more registration hand postures and displaying a registration posture guide on the display surface is triggered responsive to a touch input on the display surface failing to change at a predetermined rate.

9. The method of claim 1, further comprising hiding the registration posture guide when a registration hand posture is performed.

10. A method for providing multi-touch input initiation training on a display surface configured to detect multi-touch input, comprising:
determining a set of one or more registration hand postures, each registration hand posture corresponding to one or more gestures executable from that registration hand posture; and
displaying a registration posture guide on the display surface, the registration posture guide including a catalogue for each registration hand posture, the catalogue including:
a contact silhouette showing a model touch-contact interface between the display surface and that registration hand posture;
a representation of one or more hands indicating parts of the one or more hands that are usable to establish the model touch-contact interface between the display surface and that registration hand posture; and
gestures available from that registration hand posture.

11. The method of claim 10, wherein the indication of parts of the one or more hands that are usable to establish the model touch-contact interface between the display surface and that registration hand posture includes highlighted regions of the representation of one or more hands.

12. The method of claim 10, wherein the gestures available from that registration hand posture includes a first gesture displayed with a first color and a second gesture displayed with a second color different from the first color.

13. The method of claim 10, wherein determining a set of one or more registration hand postures and displaying a registration posture guide on the display surface is triggered by a user request.

14. The method of claim 13, wherein the user request includes a touch input on the display surface.

15. The method of claim 10, wherein determining a set of one or more registration hand postures and displaying a registration posture guide on the display surface is triggered responsive to a touch input on the display surface failing to change at a predetermined rate.

16. The method of claim 10, further comprising hiding the registration posture guide when a touch input on the display surface changes at a predetermined rate.

17. The method of claim 10, further comprising hiding the registration posture guide when a registration hand posture is performed.

18. A computing system, comprising:
a display surface configured to receive touch input;
a logic subsystem operatively connected to the display surface; and
a data-holding subsystem holding instructions executable by the logic subsystem to:
determine a set of one or more registration hand postures, each registration hand posture corresponding to one or more gestures executable from that registration hand posture; and
display a registration posture guide on the display surface, the registration posture guide including a catalogue for each registration hand posture, the catalogue including a contact silhouette showing a model touch-contact interface between the display surface and that registration hand posture.

19. The system of claim 18, wherein the catalogue further includes a representation of one or more hands indicating parts of the one or more hands that are usable to establish the model touch-contact interface between the display surface and that registration hand posture.

20. The system of claim 18, wherein the catalogue further includes gestures available from that registration hand posture.
